(19) United States
(12) Patent Application Publication
(10) Pub. No.: US 2015/0262027 A1
(43) Pub. Date: Sep. 17, 2015

(54) DETECTION DEVICE AND DETECTION METHOD

(71) Applicant: FUJITSU LIMITED, Kawasaki-shi (JP)

(72) Inventor: Masashi SATOMI, Kawasaki (JP)

(21) Appl. No.: 14/643,602

(22) Filed: Mar. 10, 2015

(30) Foreign Application Priority Data
Mar. 14, 2014 (JP) 2014-052179

(51) Int. Cl. G06K 9/46; G06K 9/00; G06T 7/00

(52) U.S. Cl. CPC G06K 9/4661; G06T 7/0097; G06T 7/0081; G06K 9/00234; G06K 9/00255; G06K 9/4647; G06T 2207/10016; G06T 2207/20021; G06T 2207/30201; G06T 2207/30048; G06T 2207/20148

(57) ABSTRACT

A device for generating heartbeat information of an object, includes circuitry configured to acquire a plurality of images of the object, the plurality of images being captured in a time series and including a first image and a second image, generate a luminance difference between a first segment in the first image and a second segment in the second image, the first segment and the second segment corresponding to a specific part of the object, execute a determination process for the first segment in the first image when the luminance difference is less than a threshold value, the determination process determining a value indicating a state of the object at a time when an image is captured based on luminance information of a segment in the image, and generate the heartbeat information based on a first value of the first image and other values of other images.

### CROSS-REFERENCE TO RELATED APPLICATION

This application is based upon and claims the benefit of priority of the prior Japanese Patent Application No. 2014-052179, filed on Mar. 14, 2014, the entire contents of which are incorporated herein by reference.

### FIELD

The embodiments discussed herein are related to a technique for detecting a pulse wave.

### BACKGROUND

Conventionally, there have been proposed detection devices (which will be hereinafter referred to as “pulse wave detection devices” occasionally) which detect a pulse wave of a person, which is associated with a heartbeat. A conventional pulse wave detection device obtains a plurality of image frames in which a person is imaged and specifies a face image area in each image frame. Then, the conventional pulse wave detection device sets a specific “frame” in the specified face image area. The “frame” is set so as not to include images of the eyes and the mouth. The “frame” has a rectangular shape with a long side extending in the lateral direction of the face. Then, the conventional pulse wave detection device calculates an average value of luminance of all pixels in the set frame. The average value of the luminance is calculated for each frequency component (for example, red (R), green (G), and blue (B)). The conventional pulse wave detection device detects a pulse wave based on the calculated average value of the luminance. That is, because a change in time of the calculated average value of the luminance corresponds to the pulse wave, the pulse wave may be detected by detecting the change in time thereof. In detection of the pulse wave, a frequency component G is mainly used. A frequency component R and a frequency component B are used for removing noise components. Based on the pulse wave detected in the above-described manner, the heart rate of a person may be calculated. Note that the related art techniques are disclosed in Japanese Laid-open Patent Publication No. 2013-101419 and Japanese Laid-open Patent Publication No. 2011-130996.

### SUMMARY

According to an aspect of the invention, a device for generating heartbeat information associated with a heartbeat of an object, includes circuitry configured to acquire a plurality of images of the object, the plurality of images being captured in a time series and including a first image and a second image, generate a luminance difference between a first segment in the first image and a second segment in the second image, the first segment and the second segment corresponding to a specific part of the object, execute a determination process for the first segment in the first image when the luminance difference is less than a threshold value, the determination process determining a value indicating a state of the object at a time when an image is captured based on luminance information of a segment in the image, and generate the heartbeat information based on a first value which is determined by executing the determination process for the first image and other values which are determined by executing the determination process for other images included in the plurality of images.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example pulse wave detection device according to a first embodiment;

FIG. 2 is a block diagram illustrating an example calculation section according to the first embodiment;

FIG. 3 is a flow chart illustrating an example of a processing operation performed by the pulse wave detection device according to the first embodiment;

FIG. 4 is a view illustrating processing of calculating a luminance average in a target frame; and

FIG. 5 is a diagram illustrating a hardware configuration example of a pulse wave detection device.

### DESCRIPTION OF EMBODIMENTS

Specifically, when image shooting is performed outdoors, depending on the environment light, the luminance of an image might greatly varies between frames. Specifically, when an image of a person in a transportation device, such as a vehicle, and the like, is used, the luminance of the image might possibly vary greatly. Such a variation in luminance of an image due to the environment light might possibly reduce the accuracy of pulse wave detection. A pulse wave is useful for detecting heartbeat information associated with a person and corresponding heart rate information.

However, in conventional pulse wave detection devices, reduction in accuracy of pulse wave detection due to the environment light is not taken into consideration, and therefore, there is a probability that the accuracy of pulse wave detection is reduced.

In view of the foregoing, a technique disclosed herein has been devised, and it is therefore an object of the present disclosure is to provide a detection device, a medium storing a detection program, and a detection method that allow improvement of accuracy of pulse wave detection.

Embodiments of a detection device, a detection program, and a detection method according to the present disclosure will be described in detail with reference to the accompanying drawings. Note that a detection device, a medium storing a detection program, and a detection method according to the present disclosure are not limited to the embodiments.

### First Embodiment

Configuration Example of Pulse Wave Detection Device

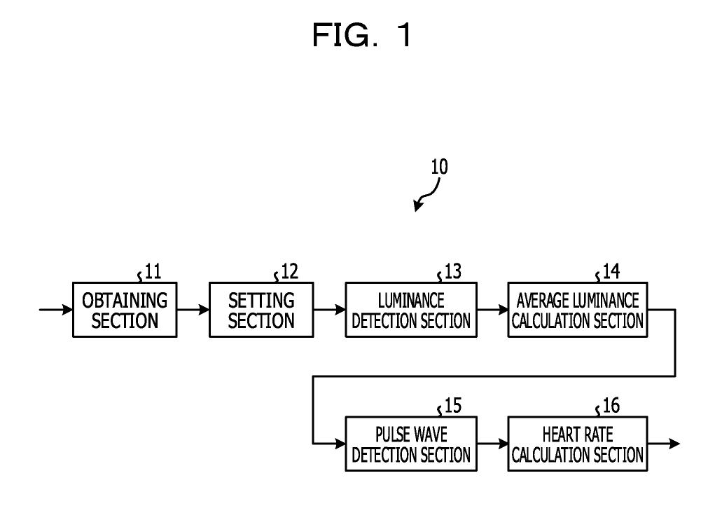

FIG. 1 is a block diagram illustrating an example pulse wave detection device according to a first embodiment. In FIG. 1, a pulse wave detection device 10 includes an obtaining section 11, a setting section 12, a luminance detection section 13, an average luminance calculation section 14, a pulse wave detection section 15, and a heart rate calculation section 16. The pulse wave detection device 10 is a device that detects a pulse wave based on an average luminance value in an “analysis area” of each of a plurality of image frames of a captured image of a target object for pulse wave detection. The pulse wave detection device 10 may be mounted in a vehicle, a mobile terminal, or the like.

The obtaining section 11 obtains, in time series, a plurality of image frames of an image of a target object for pulse wave detection, which is captured by an imaging device (not illustrated), and outputs the obtained plurality of image frames to the setting section 12. The target object for pulse wave detection is, for example, a person.

The setting section 12 sets a “candidate analysis area” for each image frame received from the obtaining section 11. The “candidate analysis area” includes a plurality of segments (that is, zones). For example, as the “candidate analysis area”, a specific frame is set, and an area surrounded by the frame is divided into portions of n rows and m columns arranged in a lattice pattern, and (n×m) divided areas are set. Each of n and m is a natural number of 2 or more. The divided areas correspond to the above-described segments. Each segment may include a single pixel or may include a plurality of pixels.

The setting section 12 may be configured to specify an image area associated with a specific part of a person. The specific part of the person can be the face and, in connection with this example, the specified image area is hereinafter referred to as a “face image area”. The image area is specified in each image frame and the setting section 12 sets the “candidate analysis area” in the face image area which has been specified and does not include the eyes and the mouth. Thus, the accuracy of pulse wave detection may be increased.

The setting section 12 outputs each image frame in which the “candidate analysis area” is set to the luminance detection section 13.

The luminance detection section 13 receives, from the setting section 12, the plurality of image frames in which the “candidate analysis area” is set. The luminance detection section 13 determines the luminance of each segment in the “candidate analysis area” for each image frame. Then, the luminance detection section 13 outputs a detection luminance value to the average luminance calculation section 14 in association with a frame number and a segment number (for example, a first column of a kth row). In this case, the luminance detection section 13 determines the luminance for each frequency component (for example, red (R), green (G), and blue (B)).

The average luminance calculation section 14 sequentially assumes each of the plurality of image frames as a “target frame” and thus calculates an average luminance value in the “analysis area” of the target frame. For example, the average luminance calculation section 14 calculates, as an average luminance value in the analysis area of the target frame, an average luminance value of a segment group including ones of the plurality of segments in the candidate analysis area of the target frame other than segments thereof with a luminance difference of a predetermined level or more from the luminance of a corresponding segment of a frame preceding the target frame. A comparison target of comparison of luminance which is compared to the luminance of a segment of the target frame is a segment of a frame immediately preceding the target frame. The average luminance value is calculated for each of the above-described frequency components.

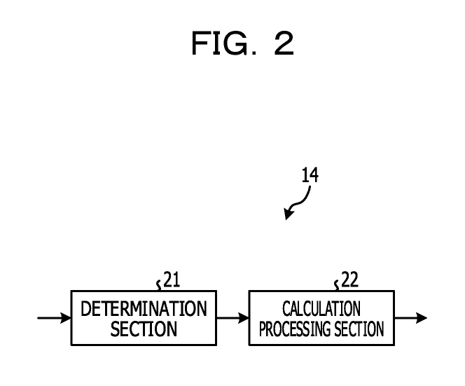

For example, as illustrated in FIG. 2, the average luminance calculation section 14 includes a determination section 21 and a calculation processing section 22. FIG. 2 is a block diagram illustrating an example calculation section according to the first embodiment.

The determination section 21 determines whether or not a difference between the luminance of each segment of the candidate analysis area of the target frame and the luminance of a corresponding segment of a frame immediately preceding the target frame is a predetermined value or more.

Using the luminance of a segment for which the difference is determined not to be the predetermined value or more by the determination section 21, the calculation processing section 22 calculates the average luminance value in the analysis area of the target frame. Thus, a luminance average may be obtained using the luminance of other segments than segments that are presumed to be influenced by the environment light. By detecting a pulse wave using the average luminance value obtained in the above-described manner, the accuracy of pulse wave detection may be increased.

Then, the calculation processing section 22 outputs the average luminance value calculated for the analysis area of each image frame in association with the frame number. The output average luminance value may be stored in association with the frame number in a storage section (not illustrated).

The pulse wave detection section 15 executes “pulse wave detection processing” based on the average luminance value calculated by the calculation processing section 22. For example, in the “pulse wave detection processing”, the pulse wave detection section 15 detects, as the waveform of a pulse wave, a fluctuation in the average luminance value relative to time for the frequency component G. In the “pulse wave detection processing”, noise removal processing and resampling processing both using the frequency component R and the frequency component B may be performed.

The heart rate calculation section 16 calculates a heart rate based on the waveform of the pulse wave detected by the pulse wave detection section 15 and outputs the value of the calculated heart rate.

Example of Operation of Pulse Wave Detection Device

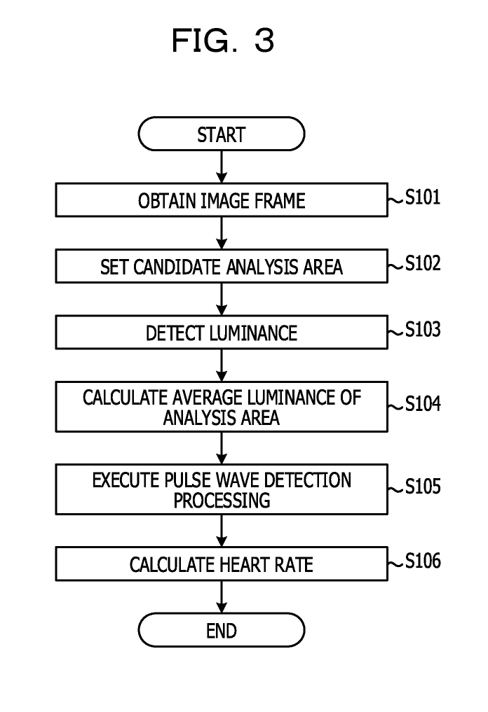

An example of the operation of a pulse wave detection having the above-described configuration will be described. FIG. 3 is a flow chart illustrating an example of a processing operation performed by the pulse wave detection device according to the first embodiment.

The obtaining section 11 obtains a plurality of image frames of an image of the face of a person that is a target object for pulse wave detection, which is captured by an imaging device (not illustrated) (Step S101).

The setting section 12 sets the above-described “candidate analysis area” for each image frame received by the obtaining section 11 (Step S102).

The luminance detection section 13 determines the luminance of each segment in the “candidate analysis area” for each image frame (Step S103).

The average luminance calculation section 14 sequentially assumes each of the plurality of image frames as a “target frame” and calculates an average luminance value in the “analysis area” of the target frame (Step S104). For example, the average luminance calculation section 14 calculates, as an average luminance value in the analysis area of the target frame, an average luminance value of a segment group including ones of the plurality of segments in the candidate analysis area of the target frame other than ones of the plurality of segments with a luminance difference of a predetermined level or more from the luminance of a corresponding segment of a frame preceding the target frame.

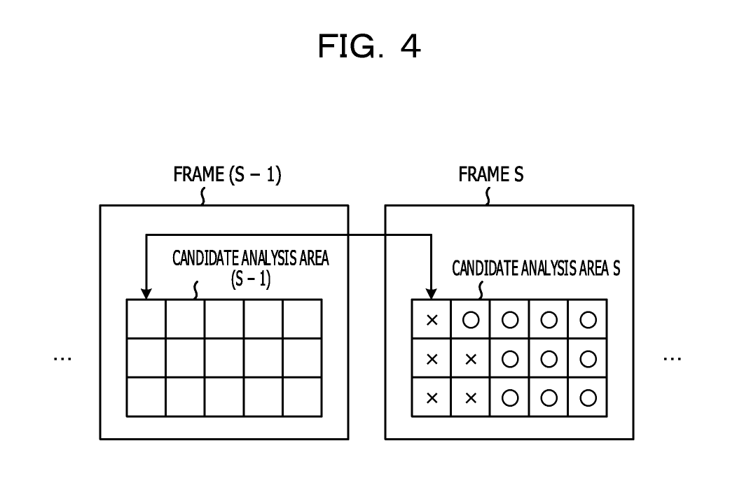

FIG. 4 is a view illustrating processing of calculating a luminance average in a target frame. In FIG. 4, the candidate analysis area when m=3 and n=5 hold is illustrated as an example. That is, in this case, the candidate analysis area includes 15 segments.

When the target frame is a frame S, the average luminance calculation section 14 compares the luminance value of a segment (k, l) of a candidate analysis area S set in the frame S and the luminance value of a segment (k, l) of a candidate analysis area (S−1) set in the frame (S−1) to each other. Then, if the luminance value of the segment (k, l) of the candidate analysis area S is different from the luminance value of the segment (k, l) of the candidate analysis area (S−1) by a predetermined level or more, the average luminance calculation section 14 removes the segment (k, l) of the candidate analysis area S from the analysis area, that is, does not include the segment (k, l) of the candidate analysis area S in the analysis area. In an example illustrated in FIG. 4, for example, a segment (1, 1) of the candidate analysis area S is removed from the analysis area. Also, for example, a segment (1, 2) of the candidate analysis area S is included in the analysis area. In FIG. 4, each segment removed from the analysis area is denoted by a cross, and each segment included in the analysis area is denoted by a circle. That is, as illustrated in FIG. 4, a segment group of segments each being denoted by a “circle” forms the analysis area in the frame S.

Returning to the description of FIG. 3, the pulse wave detection section 15 executes the “pulse wave detection processing” based on the average luminance value calculated in Step S104 (Step S105). For example, in the “pulse wave detection processing”, the pulse wave detection section 15 detects, as the waveform of a pulse wave, a fluctuation in the average luminance value relative to time for the frequency component G. Also, in the “pulse wave detection processing”, noise removal processing and resampling processing both using the frequency component R and the frequency component B may be performed.

The heart rate calculation section 16 calculates a heart rate based on the waveform of the pulse wave detected in Step S105 (Step S106).

As described above, according to this embodiment, in the pulse wave detection device 10, the setting section 12 sets a “candidate analysis area” for each image frame received from the obtaining section 11. The “candidate analysis area” includes a plurality of segments (that is, zones). The average luminance calculation section 14 sequentially assumes each of the plurality of image frames as a “target frame” and calculates the average luminance value in the “analysis area” of the target frame. Specifically, the average luminance calculation section 14 calculates, as an average luminance value in the analysis area of the target frame, an average luminance value of a segment group including ones of the plurality of segments in the candidate analysis area of the target frame other than ones of the plurality of segments with a luminance difference of a predetermined level or more from the luminance of a corresponding segment of a frame preceding the target frame.

For example, in the average luminance calculation section 14, the determination section 21 determines whether or not a difference between the luminance of each segment of the candidate analysis area of the target frame and the luminance of a corresponding segment of a frame immediately preceding the target frame is a predetermined value or more. Then, using the luminance of a segment for which the luminance difference is determined not to be the predetermined value or more by the determination section 21, the calculation processing section 22 calculates the average luminance value in the analysis area of the target frame.

With the above-described configuration of the pulse wave detection device 10, it is possible to remove, for example, segments that are presumed to be influenced by the environment light from the analysis area, not to include all segments of the candidate analysis area in the analysis area. Pulse wave detection may be performed using the average luminance value of the analysis area, which is obtained in the above-described manner, the accuracy of pulse wave detection may be increased, thereby improving the ability to generate heartbeat information associated with the heartbeat of a person and determining heart rate.

### Other Embodiments

[1] In the first embodiment, the comparison target, of which the luminance is compared to the luminance of a segment of the target frame, is a segment of a frame immediately preceding the target frame, but the comparison target is not limited thereto. For example, the comparison target, of which the luminance is compared to the luminance of a segment of the target frame, may be a segment of a frame N frames preceding the target frame. N is a natural number of 2 or more. In this case, for example, if the difference between the luminance value of the segment of the target frame and the luminance of the target segment of any one of the N frames is a certain level, when being compared to each other, the segment of the target frame may be included in the analysis area.

[2] The pulse wave detection device 10 according to the first embodiment may be mounted, for example, in an automobile. In this case, position information for a position, at which an image of the face of a driver of each automobile is captured, and a heart rate obtained from a face image are stored in association with each other. The detection device analyzes the stored information, thus allowing specifying a place where the heart rate of the driver increases, that is, a place where the risk is high.

[3] Each component element of each unit illustrated in the drawings in the first embodiment may not be physically configured as illustrated in the drawings. That is, specific embodiments of disintegration and integration of each unit are not limited to those illustrated in the drawings, and all or some of the units may be disintegrated/integrated functionally or physically in an arbitrary unit in accordance with various loads, use conditions, and the like.

Furthermore, all or some of the processing functions performed by each unit may be executed by a central processing unit (CPU) or a micro computer, such as a micro processing unit (MPU), a micro controller unit (MCU), and the like. Also, all or some of the processing functions may be executed on a program analyzed and executed by a CPU (or a micro computer, such as an MPU, MCU, and the like) or a hardware by wired logic.

A pulse wave detection device according to the first embodiment may be realized by, for example, the following hardware configuration.

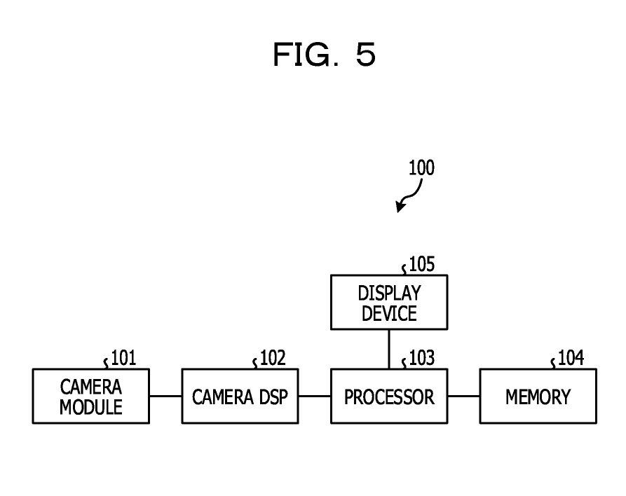

FIG. 5 is a diagram illustrating a hardware configuration example of a pulse wave detection device. As illustrated in FIG. 5, a pulse wave detection device 100 includes, a camera module 101, a camera digital signal processor (DSP) 102, a processor 103, a memory 104, and a display device 105. Examples of the processor 103 include a CPU, a DSP, a field programmable gate array (FPGA), and the like. Examples of the memory 104 include a random access memory (RAM), such as a synchronous dynamic random access memory (SDRAM) and the like, a read only memory (ROM), a flash memory, and the like.

The processing functions performed by a pulse wave detection device according to the first embodiment may be realized by causing a processor to execute programs stored in various memories, such as a non-volatile memory medium.

That is, a program corresponding to the processing executed by each the obtaining section 11, the setting section 12, the luminance detection section 13, the average luminance calculation section 14, the pulse wave detection section 15, and the heart rate calculation section 16 may be stored in the memory 104, and may be executed by the processor 103.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A device for generating heartbeat information associated with a heartbeat of an object, comprising:
circuitry configured to:
acquire a plurality of images of the object, the plurality of images being captured in a time series and including a first image and a second image,
generate a luminance difference between a first segment in the first image and a second segment in the second image, the first segment and the second segment corresponding to a specific part of the object,
execute a determination process for the first segment in the first image when the luminance difference is less than a threshold value, the determination process determining a value indicating a state of the object at a time when an image is captured based on luminance information of a segment in the image, and
generate the heartbeat information based on a first value which is determined by executing the determination process for the first image and other values which are determined by executing the determination process for other images included in the plurality of images.

2. The device according to claim 1, wherein the circuitry is further configured to:
set a first area in the first image corresponding to the specific part,
divide the first area into a plurality of first segments including the first segment,
set a second area in the second image corresponding to the specific part, and
divide the second area into a plurality of second segments including the second segment.

3. The device according to claim 2, wherein
the circuitry is further configured to generate a plurality of luminance differences between each of the plurality of first segments and each of the plurality of second segments, the each of the plurality of second segments corresponding to each of the plurality of first segments locationally, and
the first value is determined using one or more first segments of which the luminance difference is less than the threshold.

4. The device according to claim 3, wherein the first value represents an average of luminance values of a plurality of pixels included in the one or more first segments.

5. The device according to claim 1, wherein the object is a person.

6. The device according to claim 5, wherein the specific part includes a face of the person.

7. The device according to claim 1, wherein the first image is captured following the second image.

8. The device according to claim 1, wherein
the first luminance information includes red component, a blue component, and a green component, and
the first value is determined using the green component.

9. A method for generating heartbeat information associated with a heartbeat of an object, the method comprising:
acquiring a plurality of images of the object, the plurality of images being captured in a time series and including a first image and a second image;
generating a luminance difference between a first segment in the first image and a second segment in the second image, the first segment and the second segment corresponding to a specific part of the object;
executing, by a processor, a determination process for the first segment in the first image when the luminance difference is less than a threshold value, the determination process determining a value indicating a state of the object at a time when an image is captured based on luminance information of a segment in the image; and
generating the heartbeat information based on a first value which is determined by executing the determination process for the first image and other values which are determined by executing the determination process for other images included in the plurality of images.

10. The method according to claim 9, further comprising:
setting a first area in the first image corresponding to the specific part;
dividing the first area into a plurality of first segments including the first segment;
setting a second area in the second image corresponding to the specific part; and
dividing the second area into a plurality of second segments including the second segment.

11. The method according to claim 10, further comprising:
generating a plurality of luminance differences between each of the plurality of first segments and each of the plurality of second segments, the each of the plurality of second segments corresponding to each of the plurality of first segments locationally, and
wherein the first value is determined using one or more first segments of which the luminance difference is less than the threshold.

12. The method according to claim 11, wherein the first value represents an average of luminance values of a plurality of pixels included in the one or more first segments.

13. The method according to claim 9, wherein the object is a person.

14. The method according to claim 13, wherein the specific part includes a face of the person.

15. The method according to claim 9, wherein the first image is captured following the second image.

16. The method according to claim 9, wherein
the first luminance information includes red component, a blue component, and a green component, and
the first value is determined using the green component.

17. A non-transitory computer-readable storage medium storing a program for generating heartbeat information associated with a heartbeat of an object, the program causing a circuitry to:
acquire a plurality of images of the object, the plurality of images being captured in a time series and including a first image and a second image,
generate a luminance difference between a first segment in the first image and a second segment in the second image, the first segment and the second segment corresponding to a specific part of the object,
execute a determination process for the first segment in the first image when the luminance difference is less than a threshold value, the determination process determining a value indicating a state of the object at a time when an image is captured based on luminance information of a segment in the image, and
generate the heartbeat information based on a first value which is determined by executing the determination process for the first image and other values which are determined by executing the determination process for other images included in the plurality of images.
